(19) United States
(12) Patent Application Publication
(10) Pub. No.: US 2014/0354993 A1
(43) Pub. Date: Dec. 4, 2014

(54) LOCALIZED SURFACE PLASMON RESONANCE SENSING SYSTEM WITH ANISOTROPIC PARTICLES

(71) Applicant: NATIONAL CHENG KUNG UNIVERSITY, TAINAN CITY (TW)

(72) Inventors: CHUN-HUNG LIN, TAINAN CITY (TW); WEN-YU CHEN, TAINAN CITY (TW)

(73) Assignee: NATIONAL CHENG KUNG UNIVERSITY, TAINAN CITY (TW)

(21) Appl. No.: 14/080,957

(22) Filed: Nov. 15, 2013

(30) Foreign Application Priority Data
May 30, 2013 (TW) 102119085

(51) Int. Cl. G01N 21/55

(52) U.S. Cl. CPC G01N 21/554
USPC 356/369

(57) ABSTRACT

A localized surface plasmon resonance (LSPR) sensing system with anisotropic particles is revealed. The anisotropy of nanoparticles spectrally splits the phase spectra of two perpendicular polarizations thus inducing a phase difference between the two polarizations. An apparatus of ellipsometry is used to measure the phase difference. The simulated results demonstrate that the full width at the half maximum of the spectrum of phase difference is much narrower than the spectrum of transmittance. Therefore the figure of merit is dramatically increased and the performance of the refractive index sensor is improved.

### BACKGROUND OF THE INVENTION

1. Field of the Invention

The present invention relates to a localized surface plasmon resonance (LSPR) sensing system with anisotropic particles, especially to a LSPR sensing system in which the spectra of two orthogonal polarizations of transmitted light or reflected light are slightly shift away from each other due to anisotropic shape of meal nanoparticles deposited on the test specimen. Thus a signal of phase difference with a quite narrow bandwidth is generated and can be measured by ellipsometry. Therefore the figure of merit of the sensing system is significantly improved.

2. Description of Related Art

The LSPR is a collective oscillation of free electrons in metal nanoparticles when excited by electromagnetic waves. The LSPR induces peaks or troughs in spectra of absorption, scattering, transmittance or reflectance at the resonance frequency. The resonance frequency of metal nanoparticles will shift due to delicate change of refractive index of the environment which can be caused by binding of molecules on nanoparticles or change of solution density of chemical substances, etc. Thus the refractive index changes can be learned by monitoring the spectral shift of resonance frequency. The LSPR technique with advantages of high sensitivity and real-time detection has been widely used in chemical and biological sensors. The sensitivity of sensor is defined as the spectral shift divided by a refractive index change. In addition to the sensitivity, the capability of sensor is also concerned with the full width at half maximum (FWHM) of the peak/trough. A figure of merit (FOM) defined as the sensitivity divided by the FWHM is widely used to characterize the senor performance. It can be expected that the sensor with narrower bandwidth has better quality/performance among sensors with the same sensitivity.

The LSPR sensors offer small FOM typically ranging from 1 to 2 owing to the broad line shape of LSPR. In recent years, many methods for restraining the FWHM to improve the FOM have been proposed. Leif J. Sherry et al. (Nano Lett. 5, 2034 (2005)) observed a higher order mode of nanocubes excited by the contact of the substrate. The mode possesses a FWHM narrower than the dipole mode, and thus resulting in a higher FOM. Peter Offermans et al. (ACS Nano 5, 5151 (2011)) demonstrated an enhanced FOM of sensor of periodic arranged nanoparticles. The coupling of Wood-Rayleigh anomaly and the LSPR restrains the FWHM of the senor. Currently, most of the proposed methods are based on detection of light intensity. However, according to the research of Andrei V. Kabashin et al. (Opt. Express 17, 21191 (2009)), phase detection algorithms with the advantages of higher signal-to-noise ratios and better sensitivities give the possibility to achieve lower detection limits.

A novel phase detection algorithm with wavelength interrogation is proposed by Kristof Lodewijks et al. (Nano Lett. 12, 1655 (2012)). They designed test specimen which are composed of a gold thin film, a dielectric layer and a nanoparticle layer. In the instrument, the resonant frequency of S polarization and P polarization is separated by oblique incidence and thus a phase difference is generated between the two polarization states. The bandwidth of the phase signal measured by ellipsometry is narrower than the bandwidth of the reflectance so that the FOM is increased 6.1 times. However, the fabrication process of the test specimens is more complicated than general LSPR test specimen due to the additional gold thin film and the dielectric layer disposed under the nanoparticle layer. Thus the manufacturing cost is increased. Moreover, its optical path is incident obliquely and is achieved by a rotary arm or more complicated optical design. The above shortcomings hinder the commercialization of the technique. Thus there is room for improvement and a need to provide a novel LSPR sensing system that overcomes the above shortcomings.

### SUMMARY OF THE INVENTION

Therefore it is a primary object of the present invention to provide a LSPR sensing system with anisotropic particles in which the spectra of two orthogonal polarization states of transmitted light or reflected light are slightly split in spectra due to anisotropic shape of meal nanoparticles. Thus a phase difference with a quite narrow bandwidth is generated between two orthogonal polarization states of the emergent light thus significantly improving the FOM of the sensing system. The embodiments according to the present invention enable the use of test specimens of one layer metal structure and the setup of a simple optical path in normal incidence. Therefore the present invention overcomes the shortcomings of the prior art.

In order to achieve the above object, a LPSR sensing system with anisotropic particles is revealed. The present invention features on that a phase signal of LSPR is generated by metal nanoparticles in anisotropic shape and the sensing is accomplished by measuring the spectral position of the phase signal. The system of the present invention includes at least one light source that produces an incident light, a polarizer for polarizing the incident light, a test specimen, an analyzer that filters out the polarization state of an emergent light passing through the test specimen, a monochromator disposed on a light path of the system and used to acquire the spectral information, and an optical detection system that receives light emerging from the test specimen and detects spectrum of a phase signal of the emergent light.

The above test specimen includes a metal nanoparticle layer formed by a plurality of metal nanoparticles. The shape of the metal nanoparticle is not with 4-fold rotational symmetry (90 degrees), in other words, the nanoparticles are anisotropic. The metal nanoparticle layer is in contact with the analyte to be tested and is excited by the incident light to sustain the LSPR. Thereby the spectra of two perpendicular polarization states of transmitted light or reflected light are slightly split away from each other due to anisotropy of the metal nanoparticles. Being measured by ellipsometry, a signal with quite narrow bandwidth is generated in the phase difference spectrum. The FWHM of the phase difference spectrum is narrower than the FWHM obtained by measuring the transmittance or reflectance. Therefore the FOM is dramatically increased and the performance of the refractive index sensor is hence improved.

The metal nanoparticle is made from metals including gold, silver, copper, aluminum, palladium, platinum, tin, white gold, etc. Moreover, the shape of the metal nanoparticle can be rectangle or ellipse. The preferred lengths of the long axis and the short axis of the metal nanoparticle matches the requirement of: 1> the length of the short axis/the length of the long axis >0.8. The metal nanoparticles are disposed on the test specimen in a periodic array or non-periodic arrangement. In an apparatus of the present invention, the layer of nanoparticles can be a porous layer of nanoholes.

The light is multichromatic to enable the spectral measurement and the light emerging from the test specimen can be transmitted light or reflected light. A preferred setup of optical path is to detect the transmitted light from the specimen under normal incidence, and hence the optical path is simple to implement and there is no need to use a rotary arm.

The light output from the test specimen is a superposition of two orthogonal polarization states. The phase signal the optical detection system measured is a difference between phases of the two orthogonal polarization states. The present system detects changes of environmental refractive index by the spectral shift in the phase difference spectrum. The spectral shift of the present system can be indicated as wavelength change, frequency change, and photon energy change.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing structure of an embodiment of a LSPR sensing system according to the present invention;

FIG. 2 is a schematic drawing showing an embodiment of a metal nanoparticle in anisotropic shape according to the present invention:

FIG. 3 is a schematic drawing showing metal nanoparticles in anisotropic shape in a metal nanoparticle layer according to the present invention;

FIG. 4 is a diagram showing simulated phases of X and Y polarization states of light passing through a test specimen as functions of wavelength in an embodiment according to the present invention;

FIG. 5 is a diagram showing phase difference between X and Y polarization states of light passing through a test specimen as a function of wavelength in an embodiment according to the present invention;

FIG. 6 is a diagram showing simulated transmittances of X and Y polarizations as functions of wavelength in an embodiment according to the present invention;

FIG. 7 is a diagram showing the phase differences Δ for nanoparticles in test specimen embedded in different environments with refractive indices of 1.33, 1.38, and 1.43;

FIG. 8 is a diagram showing a relationship between simulated FOMs of X polarization, Y polarization, and phase difference, and a length of a short side of metal nanoparticles of an embodiment according to the present invention;

FIG. 9 is a diagram showing a relationship between FOM increase ratio and a length of a short side of metal nanoparticles of an embodiment according to the present invention.

### DETAILED DESCRIPTION OF THE PREFERRED EMBODIMENT

LSPR is a collective oscillation of free electrons in metallic nanostructures. The excitation of LSPRs results in characteristic peaks and troughs in spectra of transmittance and reluctance. In addition, the phase of the transmittance and reflectance would be manipulated by the LSPR thus resulting in optical phenomena such as steep phase transition and phase retardation. The phase variations of LSPR are possible to be measured using ellipsometry. The main optical components of the ellipsometer include a light source, a polarizer, an analyzer, a monochromator, and a detector. The use of compensators in the optical path of ellipsometer is optional, depending on the applications. An ellipsometer measures the complex ratio between two perpendicular components of electric field of light such as Eₓ and E_{y}. That is

$$τ = \frac{{E}_{y}}{{E}_{x}} = tan ( ψ ) {e}^{i Δ}$$

where, tan(Ψ) is the amplitude ratio and Δ is the phase difference.

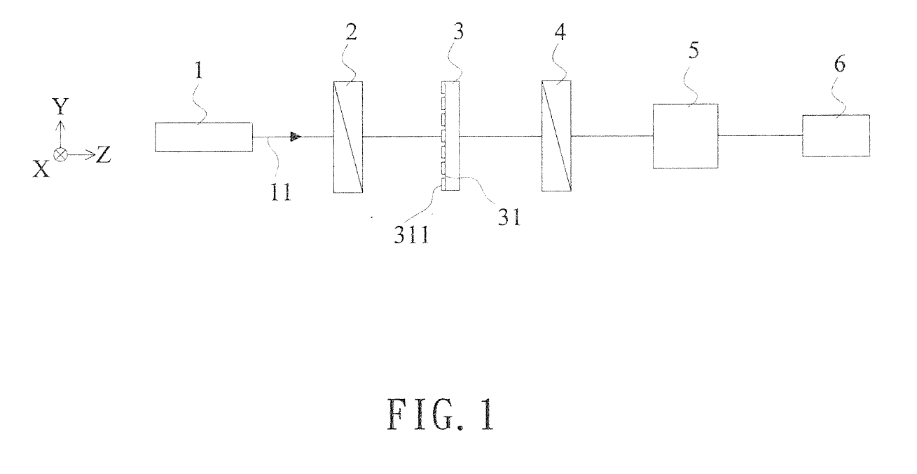

Refer to FIG. 1, a block diagram of an embodiment of a LSPR sensing system according to the present invention is revealed. The system features on that a phase signal of LSPR is generated by metal nanoparticles 311 with an anisotropic shape and the spectral shift of the phase signal is monitored by ellipsometry to detect the change of the environment of nanoparticles. The LSPR sensing system contains a light source 1, a polarizer 2, a test specimen 3, an analyzer 4, a monochromator 5, and an optical detection system 6.

The light source 1 is to generate an incident light 11. The light generated is not a monochromatic light. The bandwidth of the light is narrowed and the center wavelength is selected in the optical path by the monochromator 5 for generating the spectra.

The polarizer 2 is for polarizing the above incident light 11.

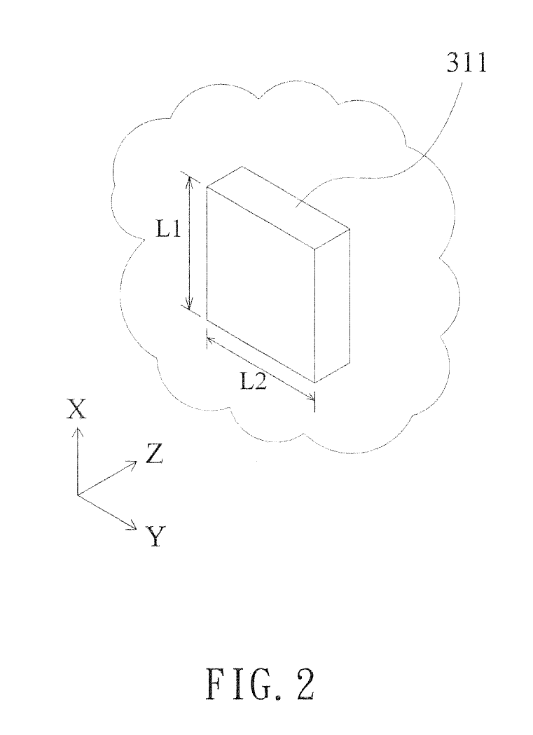

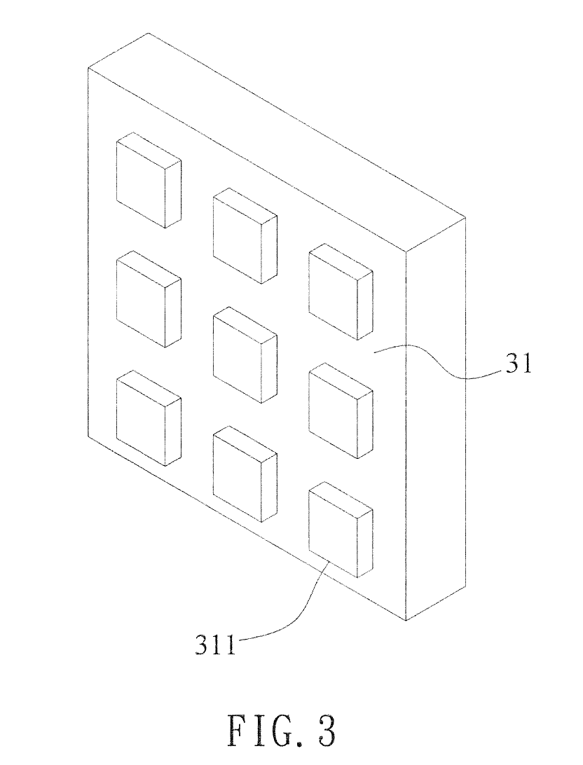

The test specimen 3 includes a metal nanoparticle layer 31. The metal nanoparticle layer 31 is formed by a plurality of metal nanoparticles 311 and is made from gold, silver, copper, aluminum, palladium, platinum, tin, white gold, etc. As shown in FIG. 2, a schematic drawing showing an embodiment of a metal nanoparticle is revealed. The shape of the metal nanoparticle is anisotropic. That means the shape of the metal nanoparticle 311 is not a square or a circle that has a 4-fold rotational symmetry. It may be rectangle or ellipse, and it is rectangle in FIG. 2. The preferred length of the metal nanoparticle 311 along the X axis and Y axis is 1> the length of the short side (L2)/the length of the long side (L1)>0.8. The metal nanoparticle layer 31 is in contact with the analyte to be tested and is excited by the incident light 11 to generate phase signals of the LSPR. Refer to FIG. 3, a schematic drawing showing metal nanoparticles 311 with anisotropic shapes in the metal nanoparticle layer 31 is revealed. In this embodiment, the metal nanoparticles 311 are arranged in a periodic array on the test specimen 3. The arrangement period along the X axis and along the Y axis can be different. The metal nanoparticles 311 can also be deposited in a non-periodic arrangement.

The analyzer 4 is for filtering out the polarization state of the emergent light after it passes through the test specimen 3. The emergent light from the test specimen 3 can be transmitted light or reflected light. In this embodiment, it's transmitted light.

The monochromator 5 is disposed on a light path of the LSPR sensing system and used for resolving the wavelength of light to acquire the spectral information. In this embodiment, the monochromator 5 is arranged behind the analyzer 4, but not limited to this position. The monochromator 5 can be disposed on the path the light of the present system passes. For example, the position can be between the light generator 1 and the polarizer 2 or between the polarizer 2 and the test specimen 3. As long as the monochromator 5 has the same effect, the position of the monochromator 5 is not limited.

The optical detection system 6 is used to receive the emergent light from the test specimen 3 and detect spectrum of the phase signal of the emergent light. The emergent light from the test specimen 3 is a superposition of two orthogonal polarization states of the light. Thus the phase signal the optical detection system 6 measured is a difference between phases of the two orthogonal polarizations. The phase signal has a spectral shift when the refractive index of the environment around the nanoparticles changes. The present system detects the change of environmental refractive index by monitoring the spectral shift. The spectral shift of the phase signal can be represented as one of the follows: wavelength change, frequency change and photon energy change.

In accordance with the above description, in the LSPR sensing system, the test specimen 3 is formed by a layer of silver rectangle nanoparticles 31 deposited on a glass substrate, the length of the long side L1 (X-axis) of the metal nanoparticle 311 is 250 nm, the length of the short side L2 (Y-axis) of the metal nanoparticle 311 is 240 nm, the period is 500 nm, and the environmental refractive index is 1.33. To present the function of the embodiment, the spectra of X and Y polarizations of light passing through the test specimen 3 are given by rigorous coupled wave analysis.

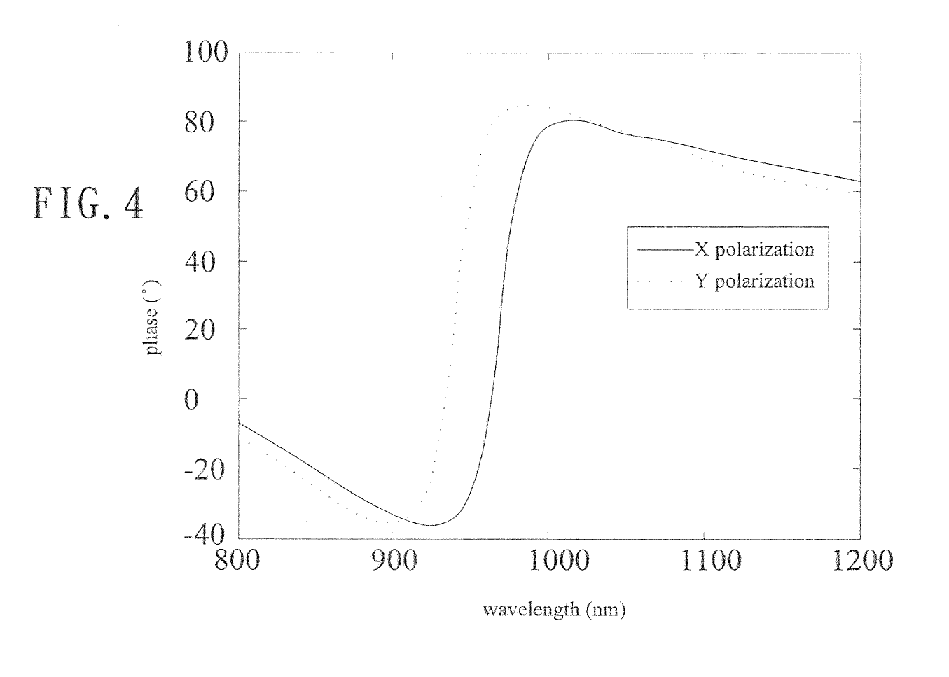

Refer to FIG. 4, the simulated phase spectrum of Y polarization ( . . . dotted line) is shifted to a shorter wavelength, relative to the simulated phase spectrum of X polarization ( - solid line), due to that the length of the Y-axis of the metal nanoparticle 311 is a bit smaller than the length of the X-axis. The phase spectra of X and Y polarizations show steep variations at around 950 nm wavelength, which are phase transitions induced by the LSPRs. Because of the phase transition phenomenon, a small spectral shift results in an enormous difference between the phase of X and Y polarizations.

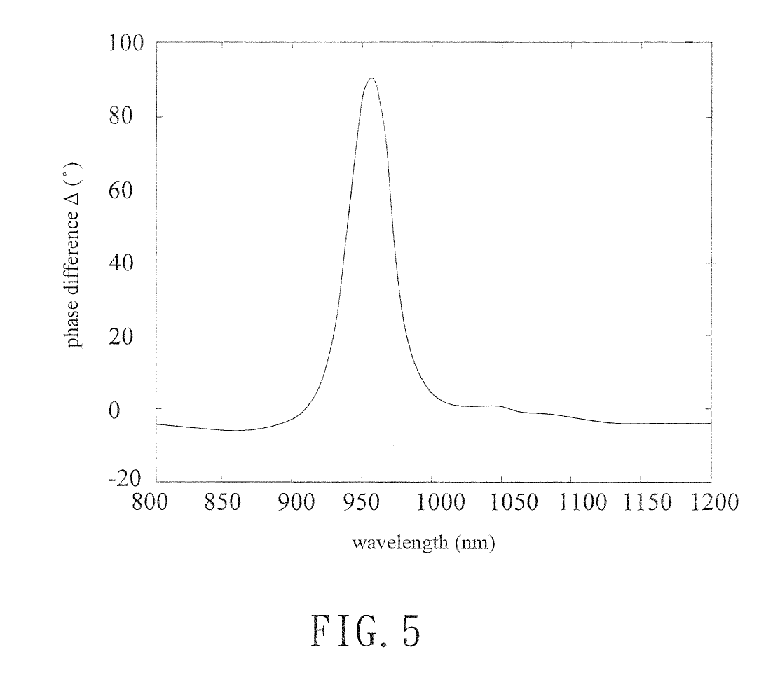

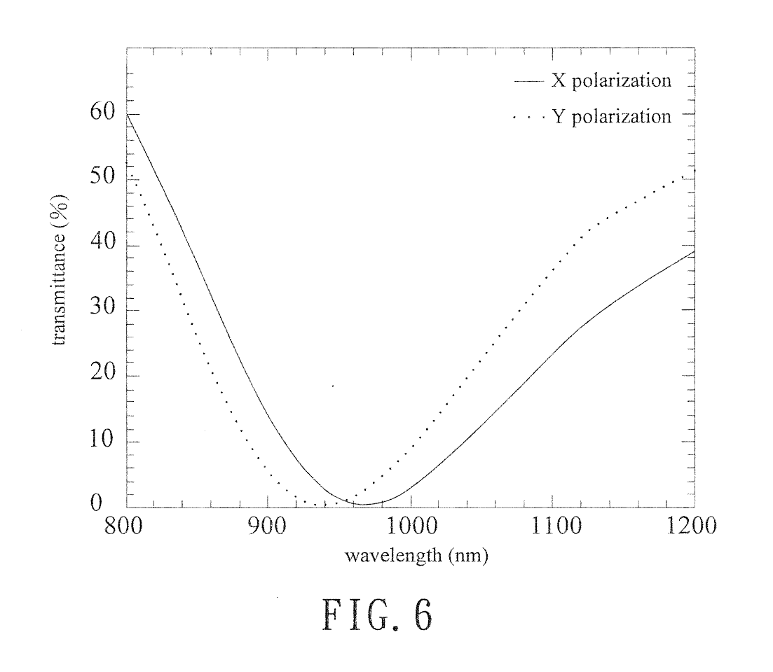

Refer to FIG. 5, the phase difference A, which is the phase of Y polarization minus the phase of X polarization in FIG. 4, is shown. In practice, the phase difference can be measured by the system of ellipsometer revealed in FIG. 1. There is a signal with a very narrow bandwidth in the spectrum of the phase difference and its FWHM is 90.4 nm. Refer to FIG. 6, the simulated transmittances of the X and Y polarizations are disclosed. The FWHM of the X polarized light and of the Y polarized light is respectively 414 nm and 351 nm. The FWHM of the spectrum of the phase difference is much narrower than the FWHMs of the transmittances. Thus the FOM of the sensing system is significantly increased.

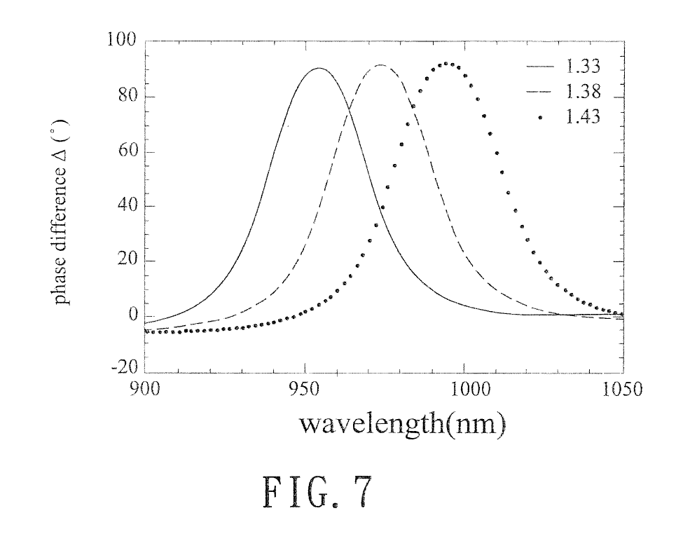

Refer to FIG. 7, the phase differences Δ for nanoparticles 311 in test specimen 3 embedded in different environments with refractive indices of 1.33 ( - solid line), 1.38 ( - - - dash line), and 1.43 ( . . . dotted line) is shown. The spectral position of phase difference Δ is red shifted with the increase of environmental refractive index. The presented embodiment of LSPR sensing system monitors the spectral shift of phase difference Δ while the test specimen 3 is in contact with analyte. The spectral shift of phase difference Δ indicates the variation of the environmental refractive index.

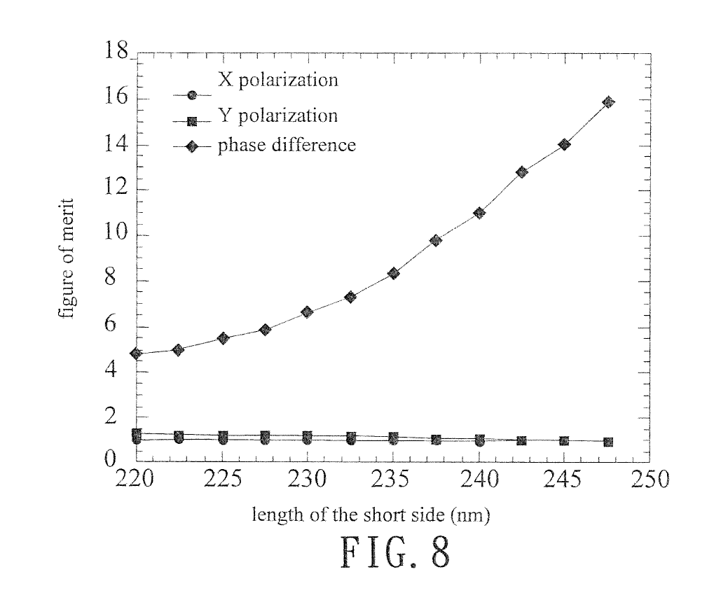

Refer to FIG. 8, a diagram showing relationship between the length of the short side (L2) of the metal nanoparticle 311 and the simulated FOMs of X polarization, Y polarization, and phase difference Δ is revealed. The length of the long side (L1) of the metal nanoparticle 311 in FIG. 2 is fixed at 250 nm. The length of the short side (L2) is varied from 220 nm to 247.5 nm. In FIG. 8, the FOM of phase difference ( -♦-diamond dots) is much higher than the FOM of X polarization ( -- circle dots) and the FOM of Y polarization ( -▪- square dots). FOM of phase difference is nearly 10 when the length of the short side (L2)/the length of the long side (L1) is equal to 0.95 while the length of the short side (L2) is 237.5 nm. As the length of the short side (L2) further approaches 247.5 nm, the FOM increases to exceeding 10.

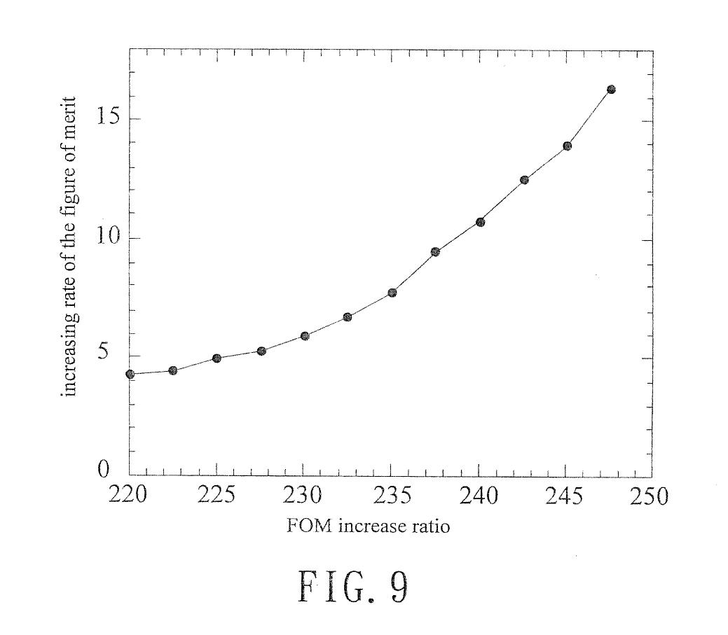

Refer to FIG. 9, a diagram showing relationship between the length (L2) of the short side and the FOM increase ratio is revealed. The FOM increase ratio is defined as FOM of the phase difference divided by average FOM of X and Y polarizations. It can be seen in FIG. 8 and FIG. 9, when the length of the short side (L2) is 245 nm, the FOM is 14.0, and the FOM increase ratio is 14.0. When the length of the short side (L2) is 247.5 nm, the FOM is 15.9, and the FOM increase ratio is 16.4.

The results show that the LSPR sensing system with anisotropic particles according to the present invention greatly enhanced the value of FOM. In addition, phase sensing technology promises a signal-to-noise ratio higher than the intensity sensing technology. The present invention is expected to obtain a lower detection limit relative to the technology of intensity sensing. Compared with the invention proposed by Kristof Lodewijks et al. (Nano Lett. 12, 1655 (2012)), there is no need to fabricate the test specimen with complicated multilayer structure, thus lowering the cost of the test specimen. Moreover, the optical path is in normal incidence so that the rotary arm is not required and the optical design is simple.

It should be noted that the rectangular shape of the metal nanoparticle 311 is only a preferred embodiment of the present invention. The metal nanoparticle 311 can be an ellipse or a ring. The arrangement of the metal nanoparticles 311 is also not limited to a rectangular array. They can be arranged into a hexagonal array or a non-periodic arrangement. Moreover, the metal nanoparticles 311 which form the metal nanoparticle layer 31 are only an embodiment of the present invention. The metal nanoparticle layer 31 can also be a porous structure of nanoholes with a similar effect and technical advantages as the above embodiment.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A localized surface plasmon resonance (LSPR) sensing system with anisotropic particles that generates a phase signal of LSPR due to anisotropy of the particles comprising:
a light source that produces an incident light;
a polarizer for polarizing the incident light,
a test specimen including a metal nanoparticle layer having a plurality of metal nanoparticles whose shape is not with 4-fold rotational symmetry; the metal nanoparticle layer is in contact with analytes to be detected and is excited by the incident light to generate phase signals of the LSPR;
an analyzer that filters out polarization state of an emergent light from the test specimen;
a monochromator disposed on a light path of the LSPR sensing system and used to resolve spectral information; and
an optical detection system that receives the emergent light from the test specimen and detects spectrum of a phase signal of the emergent light.

2. The system as claimed in claim 1, wherein the incident light is not a monochromatic light.

3. The system as claimed in claim 1, wherein the light emerging from the test specimen is transmitted light or reflected light.

4. The system as claimed in claim 1, wherein the emergent light from the test specimen is a superposition of two orthogonal polarization states; the phase signal of the emergent light detected by the optical detection system is a difference between phases of the two orthogonal polarizations.

5. The system as claimed in claim 1, wherein an interrogated information of the LSPR system is a spectral shift of the phase signal indicated as wavelength change, frequency change or photon energy change.

6. The system as claimed in claim 1, wherein material for the metal nanoparticle layer is selected from the group consisting of gold, silver, copper, aluminum, palladium, platinum, tin, and white gold.

7. The system as claimed in claim 1, wherein the metal nanoparticles are disposed on the test specimen in a periodic array.

8. The system as claimed in claim 1, wherein the metal nanoparticles are disposed on the test specimen in a random arrangement.

9. The system as claimed in claim 1, wherein the two perpendicular axes of the metal nanoparticle meet a requirement of: 1> a length of a short axis/a length of a long axis >0.8.

10. The system as claimed in claim 9, wherein the metal nanoparticle is rectangle or ellipse.
